(19) United States
(12) Patent Application Publication
(10) Pub. No.: US 2013/0073450 A1
(43) Pub. Date: Mar. 21, 2013

(54) System and Method for Facilitating Resource Conservation

(71) Applicant: David A. Swan, White Rock (CA)

(72) Inventor: David A. Swan, White Rock (CA)

(21) Appl. No.: 13/616,034

(22) Filed: Sep. 14, 2012

Related U.S. Application Data
(60) Provisional application No. 61/534,978, filed on Sep. 15, 2011.

(51) Int. Cl. G06Q 40/00

(52) U.S. Cl. 705/39

(57) ABSTRACT

A system and method for facilitating and incentivizing resource conservation. A monitoring module generates data regarding consumption of energy or other resources by one or more devices. A processing module automatically compares the resource usage data to a baseline, and determines a direct cost savings based on the comparison, optionally along with indirect value based on tax shelter value, investment, carbon offset credits, and the like. Based on this, a financial module automatically directs money to a set of financial instruments. A feedback module provides a user with indications of resource usage data, monetary value, and status of the set of financial instruments. A database configured for accumulating information related to device resource consumption, device performance, and device-related context is also provided.

### RELATED APPLICATION

This application claims the benefit under 35 USC section 119 of U.S. provisional application 61/534,978 filed on Sep. 15, 2011, the content of which is hereby incorporated by reference in its entirety and for all purposes.

### FIELD OF THE INVENTION

The present invention pertains in general to monitoring utilization of resources such as energy or other consumable resources and in particular to a system and method for facilitating resource conservation.

### BACKGROUND

Consumable resources, such as energy resources, water, and the like, are a significant recurring expense for homeowners, vehicle owners, cooperatives, public and private institutions, and the like. According to many widely accepted scenarios, the cost of such resources is expected to increase significantly in the future.

Some views hold that cost alone should provide sufficient incentive to transition to more resource-efficient technologies as they become available. However, limited awareness of consumption levels and costs, habituation to old technologies, and the like, provide practical barriers to such transitions.

Several devices are available which assist a user in monitoring their own energy or other resource consumption, and related factors such as cost. The idea is that the more aware a user is of the costs of their behaviour, the more steps they will take to reduce those costs. However, such an approach is limited by the user's discipline in terms of conservation, as well as their ability to translate potential cost reductions into real financial results. An example of such a device is the ENVI™ home energy monitor marketed by PowerSave Inc. An example of a software energy monitoring tool is Google PowerMeter™, which allows a user to track energy usage, set goals, and lower their energy usage over time, thereby reducing energy expenditures.

Energy utilities, environmental groups and other organizations sometimes publicize information such as how to reduce energy consumption, energy consumption ratings for various appliances, and the like. Incentives in the form of discounts for selected energy-efficient products may also be offered by some utilities. However, such information and incentives are typically generalized rather than personalized or highly detailed, which can lead to distrust of the information and limited usefulness. Furthermore, information is simply provided, and consumers are left on their own to capitalize or fail to capitalize on it.

Therefore there is a need for a system and method for facilitating resource conservation that is not subject to one or more limitations of the prior art.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for facilitating resource conservation. In accordance with an aspect of the present invention, there is provided a system for facilitating resource conservation, the system comprising: a monitoring module configured to generate resource usage data indicative of consumption of one or more resources by one or more devices; a processing module configured to automatically compare the resource usage data to a resource usage baseline, and to determine a monetary value indicative of at least a direct cost savings based on said comparison; a financial module configured to automatically direct money equivalent in amount to said monetary value to a predetermined set of one or more financial instruments; and a feedback module configured to provide a user associated with the one or more devices with timely feedback indicative of one or more of: the resource usage data, the monetary value, and a status of the set of financial instruments.

In accordance with an aspect of the present invention, there is provided a method for facilitating resource conservation, comprising: monitoring consumption of one or more resources by one or more devices and generating resource usage data indicative of said consumption; automatically comparing the resource usage data to a resource usage baseline, and determining a monetary value indicative of at least a direct cost savings based on said comparison; automatically directing money equivalent in amount to said monetary value to a predetermined set of one or more financial instruments; and providing a user associated with the one or more devices with timely feedback indicative of one or more of: the resource usage data, the monetary value, and a status of the set of financial instruments.

In accordance with an aspect of the present invention, there is provided a computer program product comprising a computer readable medium having computer readable code embodied therein, for execution by a CPU, for performing a method for facilitating resource conservation, the method comprising: monitoring consumption of one or more resources by one or more devices and generating resource usage data indicative of said consumption; automatically comparing the resource usage data to a resource usage baseline, and determining a monetary value indicative of at least a direct cost savings based on said comparison; automatically directing money equivalent in amount to said monetary value to a predetermined set of one or more financial instruments; and providing a user associated with the one or more devices with timely feedback indicative of one or more of: the resource usage data, the monetary value, and a status of the set of financial instruments.

### BRIEF DESCRIPTION OF THE FIGURES

These and other features of the invention will become more apparent in the following detailed description in which reference is made to the appended drawings.

FIG. 1 schematically illustrates a system for facilitating resource conservation in accordance with embodiments of the invention.

FIG. 2 schematically illustrates a method for facilitating resource conservation in accordance with embodiments of the invention.

FIG. 3 schematically illustrates directing of a monetary flow in accordance with embodiments of the invention.

FIGS. 4A and 4B schematically illustrates a system for gathering and distributing resource usage information, in accordance with embodiments of the invention.

FIG. 5 illustrates monetary flow in accordance with an embodiment of the present invention.

FIGS. 6A, 6B and 6C illustrate monetary flow between accounts in accordance with an embodiment of the present invention.

FIG. 7 illustrates a vehicle comprising computers operatively coupled to a datalogger, in accordance with an embodiment of the present invention.

### DETAILED DESCRIPTION OF THE INVENTION

### Definitions

The term “resource” refers to consumable energy-carrying media such as electricity, gasoline, diesel, propane, natural gas, hydrogen, oil, as well as other common consumables such as water. Generally, such resources are purchased in units on an as-needed basis.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

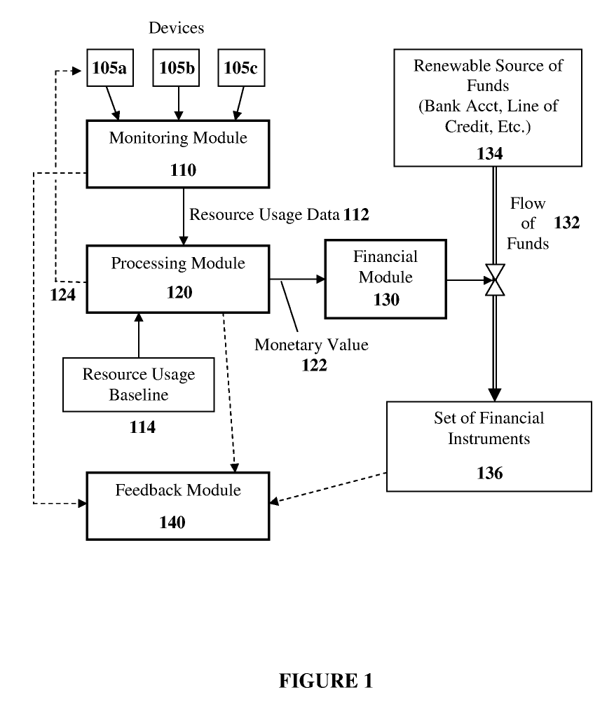

An aspect of the present technology provides a system for facilitating resource conservation, for example as illustrated in FIG. 1. The system comprises a monitoring module 110 configured to generate resource usage data 112 indicative of consumption of one or more resources by one or more devices 105a, 105b, 105c. Each device may be, for example, an appliance, mechanical or electrical equipment, a building lighting system, a building heating system, a vehicle or component of a vehicle, another system or subsystem of devices which consume or utilize predetermined resources, or the like, or a combination thereof. The system further comprises a processing module 120 configured to automatically compare the resource usage data 112 to a resource usage baseline 114, and to determine a monetary value 122 indicative of at least a direct cost savings based on said comparison. In some embodiments, the processing module 120 may at least partially automatically control 124 one or more devices 105a, 105b, 105, to adjust their operation in accordance with one or more predetermined goals, such as financial and/or resource conservation goals. The resource usage baseline 114 may be stored in memory of a local or remote computer system, for example, and may be static or adapted over time. Furthermore, in some embodiments, the processing module may comprise or be operatively coupled to a database of information which is adapted over time, as described further herein. The system further comprises a financial module 130 configured to automatically direct money equivalent in amount to said monetary value to a predetermined set of one or more financial instruments 136. For example, the money may be directed as a flow of funds 132 drawn from a source 134 such as an operating bank account, line of credit, or the like. The system further comprises a feedback module 140 configured to provide a user associated with the one or more devices with timely feedback indicative of one or more of: the resource usage data 112, the monetary value 122, and a status of the set of financial instruments 136. Output from the feedback module may facilitate and inform user-mediated control of the devices 105a, 105b, 105c, in addition to or alternatively to the automatic control 124. Based on the feedback, the user can adjust their device usage, and the adjusted device usage is then further monitored by the monitoring module. The monitoring module, processing module, financial module and feedback module, although described separately for the sake of clarity, operate together to provide the invention as described herein. In some embodiments, one or more feedback loops may be present between modules, which further reinforces their interdependence.

In embodiments of the invention, each module comprises an electronic device such as a special-purpose or general-purpose computer. Such a computer may comprise at least: a microprocessor; memory such as RAM, ROM, optical or magnetic data storage, or the like containing data and/or program instructions for executing operations associated with functionality of the module; a power supply; at least one communication interface for operative coupling to another module, a device being monitored, a financial institution, or other entity; and optionally a user interface comprising input and/or output devices. Separate modules may be implemented on separate but operatively coupled devices, or they may be provided at least in part as aspects of the same device. A computer may be configured to perform operations such as data acquisition operations, user interface operations, communication operations, and processing operations via execution of a program written in a predetermined programming language as would be readily understood by a worker skilled in the art. Various separate devices may be programmed, configured, and interconnected in order to achieve a system in accordance with the present invention. Separate devices may be substantially self-configuring, or configured during installation.

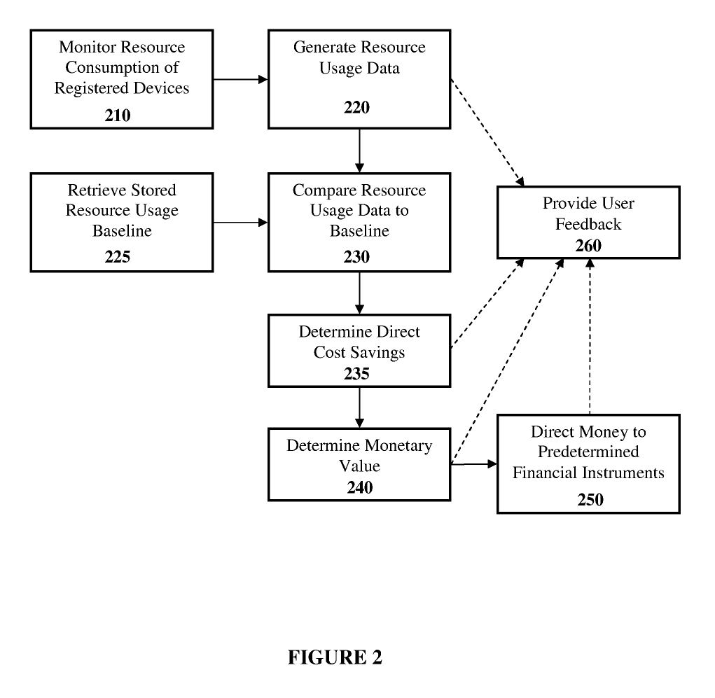

Another aspect of the present technology provides a method for facilitating resource conservation, for example as illustrated in FIG. 2. Various steps of the method may be implemented by one or more appropriately configured computing devices, which may be communicatively linked to each other and/or to other systems via a communication network or other means. The method comprises monitoring 210 consumption of one or more resources by one or more devices and generating 220 resource usage data indicative of said consumption. The method further comprises automatically comparing 230 the resource usage data to a resource usage baseline. The resource usage baseline may be retrieved 225 from memory for this purpose. The method further comprises determining 240 a monetary value indicative of at least a direct cost savings based on the comparison 230. The direct cost savings may be determined 235 in a separate step or determined together with the monetary value. The method further comprises automatically directing 250 money equivalent in amount to said monetary value to a predetermined set of one or more financial instruments. The method further comprises providing 260 a user associated with the one or more devices with timely feedback indicative of one or more of: the resource usage data, the monetary value, and a status of the set of financial instruments.

Another aspect of the present technology provides a computer program product comprising a memory having computer readable code embodied therein, for execution by a CPU, or by plural cooperating CPUs in the same device or in different, operatively coupled devices, for performing a method as described herein.

For clarity, various aspects of the present invention are described herein with respect to an apparatus. However, it will be readily understood that such aspects may be equally applied in a method, system, computer program product, or the like.

In embodiments of the invention, monetary value may be indicative of a direct cost savings and may further be indicative of one or more indirect values or cost savings resulting at least in part from the direct cost savings. Examples of indirect values or cost savings include value multipliers such as tax shelter values, carbon offset credits, government or private incentives, interest, equity, or other potential for value appreciation through financial instruments, or other financial, monetizable or inherently valuable attributes. Another example of indirect value is value derived from using or selling information such as resource usage information and related contextual information, for example as obtained and recorded in a database by a monitoring module. Incentives may flow from an external party's desire to stimulate investment in efficient or ‘green’ technologies. Value may relate to monetary and transferrable value, or another predetermined value, for example quantifying a subjective valuation system in a user-configurable manner.

In some embodiments, a direct cost savings of amount S (in dollars or other currency) may trigger inflow of an indirect value of amount kS, where k is a predetermined positive constant parameter, or a linear or nonlinear function of S. In some embodiments, k may be a substantially linear function of S over a certain domain. For example, if S dollars are saved in a taxed sheltered financial instrument such as a registered retirement savings plan (RRSP), individual retirement arrangement (IRA), 401(k), or the like, then kS may represent an income tax reduction, in dollars, due to said savings, which may be proportional to S up to a maximum amount and/or on a stepwise decreasing basis in accordance with a marginal tax system. If the energy savings are related to a saleable carbon offset credit, then k may represent a royalty rate for carbon offset credit sales per unit of resource saved, divided by the cost of the resource per unit. In some embodiments, k may further depend on factors such as opportunity costs, a portion of S to which the tax reduction or other benefit is applicable, and the like. In such models, the sum of direct cost savings and indirect values may be substantially (1+k)S. In some embodiments, k may relate to an aggregation of various factors.

In some embodiments, the system may facilitate automatic conversion of resource savings into financial assets which appreciate over time, based on automatically monitored resource consumption. Financial benefits of energy savings may further be magnified through indirect values as described above. In some embodiments, the system automatically provides a continuing value stream which may incentivize a user to conserve energy or other resources, and may provide a positive and encouraging environment in which the user may make decisions related to resource consumption.

In some embodiments, savings and/or liquidation of financial assets may be used for various purposes, such as to generate cash flow, retirement savings, to pay off loans taken out to finance energy-efficiency upgrades, to directly finance energy-efficiency upgrades, or the like. In some cases, energy-efficiency upgrades may also qualify for government or private incentives such as tax credits, which may also be accounted for when representing the value of savings to a user.

Embodiments of the present invention facilitate micro-savings, wherein small amounts of “found” money are put aside and/or invested at a time. This provides a relatively low-impact means for building up savings over time for a predetermined purpose, without requiring pre-budgeting or frequent decision making For example, at least a portion of monetary savings realized through resource conservation may be put aside or invested on daily, weekly, bi-monthly, or monthly basis, based on monitored resource consumption and an estimated or predicted cost of resources used relative to a predetermined baseline. Embodiments of the present invention facilitate positive reinforcement of user behaviour through financial benefit, micro-savings, feedback, information, goal-tracking, convenience, and the like.

Embodiments of the present invention may be used along with an invest-and-borrow strategy for financing upgrades for increasing resource usage efficiency of building envelopes, vehicles, appliances, and the like. A user can purchase units of a GIC or other financial instrument inside a tax-sheltered account such as a self-directed RRSP. The purchased units may pooled with units purchased by other users and may be used to finance equipment upgrades for users by way of a loan. Interest paid on the loan may result in a return on investment to the user, as may other third party incentives, revenue from sale of carbon offset credits facilitated by the equipment upgrades, and the like. The GIC may be a substantially standard GIC having environmental features. For example the GIC may qualify for carbon offset revenue, which may be divided between GIC holders on a pro rata basis.

In the case of RRSPs in Canada, money is invested into a tax-sheltered account. Since tax is typically paid upon earning the invested money, this often triggers a tax rebate, which can in turn be invested into an RRSP, resulting in a further tax rebate. Embodiments of the present invention may utilize a cascading contribution into RRSPs or like tax sheltered accounts. Tax rules in other jurisdictions may facilitate similar strategies.

Embodiments of the present invention are configured to assist a user in becoming cognizant of various costs and values related to resource consumption, for example by providing a visualization of same. For example, the feedback module may be configured to display amounts of resources conserved or amount of savings resulting from conservation, progress toward a goal, financial progress, or the like, in numerical or graphical form. The feedback module may further be configured to suggest equipment upgrades, detect equipment malfunctions, repair requirements, scheduled maintenance requirements, or the like, help make choices regarding resource usage, indicate performance relative to a peer group, or the like.

In embodiments of the invention, information is presented to a user in a comparative manner, for example a comparison of a user's resource usage data over time, a comparison of a user's resource usage with data from other users, or a combination thereof. One or more criteria may be used to select data which is comparable and which is likely to be relevant to a user. For example, a user's resource usage data may be compared against that of users in similar situations, locations, or the like. As another example, a user may be provided with data indicating their resource conservation performance compared to the performance of their peers. Resource usage data which is compared over time may be adapted to make the time comparison meaningful, for example by using present-day dollar values, or by using units of measurement which have the same or similar meaning over the time interval of the comparison. Examples of comparative information include: an indication of a user's rank or percentile within a group, and an indication of a user's performance as a value expressed as a percentage of a comparable historical or group performance value.

Embodiments of the present invention are configured to connect plural members of an informal or formal community, such as a business or cooperative. In some embodiments, members of the community may share information through a database or other means such as a newsletter based on information drawn from the database. In some embodiments, members of the community may be able to self-evaluate their resource usages and/or financial health in comparison aggregate information regarding other members. In some embodiments, components of the system as described herein, such as computing hardware enabling the processing module and/or financial module may be shared between members, with other components of individual members connected via a communication network. In some embodiments, the community may have access to customized financial instruments or other services, for example due to their collective negotiating power.

### Configuration Module

Embodiments of the invention may comprise a configuration module for receiving input from an installer and/or user relevant to configuration of the system. The configuration module may be used to designate, identify and label devices to be monitored, various modules and network addresses thereof if required, and the like. The configuration module may be used for inputting a resource usage baseline, establishing interoperability with financial institutions, devices, users, mobile devices, and the like. The configuration module may be used to designate financial institution particulars, bank account numbers, automated access parameters, and the like. The configuration module may comprise a computer program implemented on a computer which is operatively coupled to the remainder of the system as described herein, as would be readily understood by a worker skilled in the art.

In some embodiments, the configuration module may be configured to acquire information regarding user preferences, evaluation of non-monetary values, set user goals, join communities, and the like.

### Application of the Invention

Embodiments of the present invention relate to tools for practical use in the fields of resource usage monitoring and control, financial monitoring and control, and sharing of resource usage information between members of a group. Furthermore, embodiments of the present invention provide a technological bridge between the resource usage field and the financial field, integrated and directable by an end user.

Some embodiments of the present invention may facilitate technological application of knowledge in scientific fields such as psychology, integral with application of knowledge in applied fields such as computer science and engineering. In particular, by facilitating automated savings based on user behaviour with an attractive rate of return and with low cognitive requirements, time and stress, a typical user may be incentivized toward resource conservation. The psychological knowledge applied in embodiments of the present invention is substantially non-subjective, since positive response to such incentives as prosperity and stress reduction is a substantially universal trait. Embodiments of the present invention also provide for customization to account for more subjective user values. However, this aspect of the invention does not rely on a particular subjective value, but rather in the ability to tailor the present technology to address said values, within the framework of substantially universal values.

### Monitoring Module

Embodiments of the present invention comprise a monitoring module, configured to generate resource usage data indicative of consumption of one or more resources by one or more devices. The monitoring module may be configured to monitor resource consumption of each device individually, for example via a collection of sub-modules, or the monitoring module or a sub-module may be configured to monitor resource consumption of groups of devices, such as electrical devices fed from a common source. Each monitoring module or sub-module may be configured, for example via a transducer thereof, to receive input regarding a flow of resources to a device or devices, and to provide a signal indicative of said flow over time.

In some embodiments, the monitoring module is configured to monitor electricity supplied to a stationary device. In one embodiment, the monitoring module may comprise or be operatively coupled to a metering apparatus provided by an electrical utility. In one embodiment, the metering apparatus is a smart meter or existing home energy meter. In one embodiment, the metering apparatus is a legacy utility meter, and the monitoring module may comprise a camera configured to monitor and interpret readings therefrom, for example via optical pattern recognition, as would be readily understood by a worker skilled in the art. In one embodiment, the monitoring module may comprise electrical transducer instrumentation such as voltage transformers, current transformers, Hall effect sensors, or the like, or a combination thereof, operatively coupled to electrical conductors supplying one device or one or more groups of devices, as would be readily understood by a worker skilled in the art. The monitoring module may be configured to keep a record of power draw (for example in terms of Watts, Vars, or both), as it varies over time. The monitoring module may further be configured to keep a log of events such as when power draw increases or decreases, corresponding to device turn-on or turn-off, for example.

In some embodiments, the monitoring module is configured to monitor consumption of fuel, such as natural gas, oil, hydrogen, propane, or the like, supplied to a stationary device via a dedicated supply conduit. In some embodiments, the monitoring module may comprise a meter such as a mass flow meter, diaphragm meter, rotary meter, turbine meter, orifice meter, coriolis meter, or the like, placed in line with the supply conduit, as would be readily understood by a worker skilled in the art. In some embodiments, the monitoring module may be configured to obtain readings from an existing fluid meter, for example by receiving signals from an electronic meter, or by using a camera and processor to obtain and interpret readouts of a mechanical fluid meter.

In some embodiments, the monitoring module is configured to monitor water supplied to a stationary device via a dedicated supply conduit. In some embodiments, the monitoring module may comprise a meter such as a positive displacement meter, velocity meter mass flow meter, diaphragm meter, rotary meter, multi-jet meter, turbine meter, orifice meter, coriolis meter, or the like, placed in line with the supply conduit, as would be readily understood by a worker skilled in the art. In some embodiments, the monitoring module may be configured to obtain readings from an existing water meter, for example by receiving signals from an electronic meter, or by using a camera and processor to obtain and interpret readouts of a legacy meter.

In some embodiments, the monitoring module is configured to monitor amounts of electricity or fuel, such as gasoline, natural gas, hydrogen, propane, or the like supplied to a vehicle. The monitoring module or a portion thereof may be mounted in the vehicle or in a mobile device carried in the vehicle. In one embodiment, the monitoring module may comprise a camera, configured to obtain, and optionally manage and process, digital pictures indicative of refuelling conditions such as amount of fuel or electricity purchased, the purchase price, and any discounts applied or rewards or other incentives accumulated. In some embodiments, the vehicle-mounted portion of the monitoring module may be configured to receive such information as wirelessly transmitted by the resource retailer.

In some embodiments, a monitoring module for monitoring may be associated with a mobile device such as a smart phone, configured via software to operate as part of the monitoring module. For example, a smart phone application may be configured to obtain, and optionally manage and process, digital pictures indicative of refuelling conditions such as amount of fuel or electricity purchased, the purchase price, and any discounts applied or rewards or other incentives accumulated, and transmit same to a central portion of the monitoring module for further processing. As another example, pictures indicative of the refuelling conditions may be taken using a cellular phone and sent manually to the monitoring module using Multimedia Messaging Service (MMS), Email, or the like. Alternatively, this information may be manually entered into a mobile device via keypad, voice, or other means, or automatically received over a wireless connection, if available from the fuel or electricity retailer.

In some embodiments, the monitoring module may be configured to automatically monitor other variables which may be used to contextualize performance of monitored devices. For example, the monitoring module may be configured to monitor ambient temperature, light levels, device usage patterns such as frequency and duration of use, correlation between usage patterns of plural devices, time of day, time of year, type of use, intensity of usage, distance driven in the case of vehicles, and the like. Plural monitored characteristics may be associated and used for diagnostic or other purposes.

In some embodiments, the monitoring module may be subject to correction against other assessments, such as official assessments by utility providers, efficiency assessments of vehicles by certified mechanics, or the like. For example, amounts of electricity or gas reported by the monitoring module may be periodically compared against amounts reported on utility bills, which may be automatically or manually supplied to the monitoring module. Discrepancies may be identified and the monitoring modules may be recalibrated if required to improve accuracy thereof.

In embodiments of the present invention, a vehicle monitoring module may comprise a datalogger operatively coupled to various vehicle sensors via a standard interface such as the OBD-II system. The vehicle sensors may be standard sensors installed in the vehicle during manufacture. Data available from such sensors via the OBD-II interface may include fuel system status, operating temperatures, fuel % trim, air-to-fuel mix, engine RPM, speed, fluid flow rates, oxygen presence, pressure, fuel type, fuel ethanol content, engine timing, sensed particulates, engine run time, and the like. Such data may be obtained and stored periodically by the datalogger during vehicle operation, and may be subsequently analyzed to provide information regarding fuel resource consumption as well as contextual information associated with fuel resource consumption information, such as driving habits, engine health, conditions, and the like. In some embodiments, additional sensors, not originally provided with the vehicle, (e.g. tire pressure sensors) may be provided and linked to the vehicle monitoring module.

In some embodiments, sensor data is processed to provide an indication of fuel consumption. For example, instantaneous air-to-fuel mix information and other information obtained from sensors may be processed to provide an indication of current consumption rate of a given fuel. Such consumption rates may be logged by the datalogger on an ongoing basis, at a predetermined frequency, to provide an indication of amounts of fuel consumption over time. In embodiments of the present invention, consumption rates for multiple fuel types of a multi-fuel vehicle may be monitored and logged. For example, a multi-fuel vehicle may be a dual-fuel propane/gasoline or propane/diesel powered which uses different fuels at different times, or which may use different blends of fuels at a given time. The system may be configured to monitor consumption rates of different fuels even when they are used substantially concurrently.

In some embodiments, the datalogger may be configured for wireless communication of information obtained thereby. For example, the datalogger may comprise a wireless transceiver capable of communication via Bluetooth™, Wi-Fi™, or another wireless protocol. The datalogger may be configured to upload information to a smartphone, a home computer, a receiver located at a fuelling station, or the like. Uploading of data may be automatic, for example when an appropriate receiver is within range and a predetermined period has elapsed. Uploading may additionally or alternatively be performed upon receipt of a request by the receiving smartphone, computer, or fuelling station receiver. The smartphone, home computer, fuelling station receiver, or other recipient of datalogger information may forward the information, if required, to another component of the monitoring module. The forwarding may be performed via a machine-readable email, text message, data message, or other means. A machine-readable message may optionally be a text or ASCII-based message which follows a predetermined format which can be read and interpreted by a computer.

In some embodiments, the datalogger may wirelessly and automatically upload information to a receiver located at a fuelling station, when the vehicle is refuelled. A fuel dispenser controller at the fuelling station may also comprise a point-of-sale system which accepts a cardlock card, credit card, debit card, RFID payment fob, or other payment means. Information obtained from the payment means may be associated with the uploaded information from the datalogger. The information recorded at the fuelling station may be forwarded to other components of the monitoring module and/or processing module, either immediately or at a later time. In some embodiments the information may be at least partially analyzed, for example in aggregate and/or anonymously, by a third party, and advertising, incentives, or the like may be forwarded along with the information, for viewing by the user.

In some embodiments, a method for facilitating resource conservation, as described herein, comprises automatically and wirelessly transmitting the stored output of the one or more sensors to a receiver located at a fuelling station when the vehicle is refuelled, and forwarding the received stored output from the receiver in order to generate the resource usage data.

### Processing Module

Embodiments of the present invention comprise a processing module configured to automatically compare the resource usage data to a resource usage baseline, and to determine a monetary value indicative of at least a direct cost savings based on said comparison. The processing module is operatively coupled to the monitoring module and configured to receive the resource usage data therefrom, for example via a direct communication link or via a wired (electrical and/or optical) or wireless (radio) communication network. The processing module may further be configured to transmit data to other modules such as the financial and feedback modules, and/or a database. Communication may be executed and supported via an appropriate standard or proprietary set of communication protocols and associated wired and/or wireless communication infrastructure, as would be readily understood by a worker skilled in the art.

The processing module may comprise a special-purpose computer, or a general-purpose computer configured by appropriate software and/or firmware. The processing module may generally comprise at least a microprocessor operatively coupled to memory, a power source, and input/output hardware, as would be readily understood by a worker skilled in the art. The processor may be configured to execute instructions loaded into memory to retrieve and manipulate data saved in memory, to receive data via the input/output hardware and store same in memory, and to transmit data stored in memory via the input/output hardware.

In some embodiments, the processing module comprises or is operatively coupled to memory, such as a non-volatile memory, in which a resource usage baseline is stored. The resource usage baseline may be established based on information regarding amount of resources used during an initial period, before certain equipment upgrades or modifications to user behaviour have come into effect. The resource usage baseline may be established by actively monitoring resource usage during the initial period, or may be based on an analysis of available information such as a utility bill history. In some embodiments, the resource usage baseline may be estimated based on details such as user behaviour, average resource consumption in a relevant population, climate, and the like. In some embodiments, different baselines may be used under different conditions. For example, resource usage baselines for summer and winter, vacation and non-vacation periods, day and night, and the like may be established and used as appropriate. In some embodiments, life changes, such as change in driving or travel behaviour, addition or loss of members from the household, lifestyle changes, and the like, may trigger adjustment to the resource usage baselines, or may trigger a complete recalculation of resource usage baselines. The resource usage baseline may vary over time, for example in accordance with a moving average over a predetermined time frame, such as the time frame between installation of the system and 6 months prior to the current date.

In some embodiments, the processing module comprises or is operatively coupled to memory in which other relevant data is stored, such as current purchase prices of relevant resources such as electricity, fuel, water, and the like.

In embodiments of the present invention, the processing module is configured to determine a difference between actual usage of one or more resources and baseline usage of the same one or more resources, thereby determining an amount of resources conserved relative to the baseline. The amounts conserved may be multiplied by the current cost per unit of each resource to determine a monetary value indicative of a direct cost savings relative to the baseline resource cost. Other approaches to determining direct cost savings may also be used. For example, the amount of resources actually used and the baseline amount of resources may be pre-multiplied by the cost per unit of resource before subtraction of the two.

In embodiment of the present invention, the resource usage baseline is multiplied by the current cost of resource, including applicable taxes, to obtain a current cost of baseline-level resource usage. The actual current cost of resource usage may be subtracted from this amount to determine the monetary value indicative of a direct cost savings relative to the baseline resource cost. Comparison of current resource usage data and/or resource usage history may include comparison against the resource usage baseline.

In embodiments of the present invention, the processing module is configured to automatically control or adjust operating parameters of monitored devices based on the monitored information. Operating parameters may be adjusted so as to approach a predetermined target, such as a user-defined resource usage target, energy usage target, carbon footprint target, greenhouse gas emission target, accumulated monetary savings target, instantaneous or averaged monetary savings rate target, or the like, or a combination thereof. Automatic turn-on and turn-off times of devices such as lights may be adjusted, as may device operating parameters related to resource usage rates such as light brightness, ambient temperature within a predetermined comfort zone, and the like. Vehicles operating parameters may be adjusted so that more efficient conditions, such as speed, evenness of speed, route, and the like are preferred over less efficient conditions.

In some embodiments, comparison of the resource usage data to the resource usage baseline may comprise other operations, such as filtering, averaging, discounting, adjusting, and the like.

### Financial Module

Embodiments of the present invention comprise a financial module configured to automatically direct money equivalent in amount to said monetary value to a predetermined set of one or more financial instruments. The financial module is operatively coupled to the processing module and configured to receive the monetary value data therefrom, for example via a direct communication link or via a wired or wireless communication network. In some embodiments, the processing module and the financial module are aspects of a single computer or computer program. The financial module is further communicatively coupled to one or more financial institutions, such as banks, investment firms, or the like, and is configured and authorized to direct transactions within and/or between such institutions. Communication may be via Internet, email, or other sufficiently secure electronic communication means. Secure communication protocols such as SSL/TLS protocols would be readily understood and implementable by a worker skilled in the art. The financial module may initiate a secure connection to a server of the financial institution, provide authentication to the server, and interact with the server by sending commands and/or queries in order to direct the transactions, as would be readily understood by a worker skilled in the art.

For security reasons, the financial module in some embodiments may be authorized only to direct predetermined types of transactions, and up to only predetermined amounts. For example, the financial module may only be authorized to direct transfers of up to $100 per week from a predetermined personal chequing account to a predetermined investment account. Direction of transactions may be subject to authentication by the financial institutions. In some embodiments, user authorization may be required to execute financial transactions. These may be obtained in a non-invasive way, for example by sending an email or text message to the user to which they may reply in order to authorize the transactions. In some embodiments, authentication parameters such as passwords are not stored in memory, but rather are entered by a user as needed.

Financial instruments, to which money may be directed by the financial module, may comprise government-registered savings accounts, tax-sheltered accounts, interest-bearing investments, equity-based investments, guaranteed investment certificates, government bonds, corporate bonds, stock options, futures, or the like, as would be readily understood by a worker skilled in the art. Financial instruments may be held in accounts at a financial institution such as a bank or credit union. The allocation of investment among financial instruments may be performed by a user and/or under guidance of a registered and qualified professional. The allocation may be predetermined and input as a set of parameters in the present invention if required, or the allocation may be managed entirely by the financial institutions.

In some embodiments, a financial instrument may initially include a loan or line of credit to be paid off, for example a loan taken out to finance equipment efficiency upgrades or purchase of new devices to be monitored by the present invention. As the loan or line of credit is paid off, money may be allocated to other instruments.

In some embodiments, a financial instrument may comprise a specialized financial instrument, such as a GIC, which is used as a source of capital for loaning money to qualified users to finance upgrades which will result in improved efficiency of resource consumption.

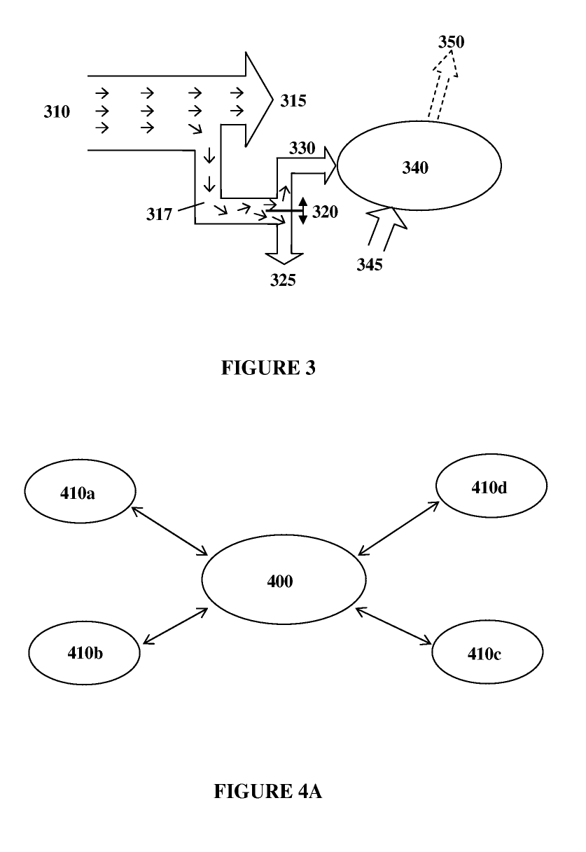

FIG. 3 illustrates monetary flow directed by a financial module or associated method step, in accordance with embodiments of the present invention. Money 310 is directed toward a variety of destinations 315, such as savings, recurring expenses, one-time expenses, and the like. In addition, money 317 is directed toward resource-related expenditures, such as payment of utility bills and/or fuel purchases. The amount of money 317 directed toward resource expenditures may be equivalent to the amount of money that would have been spent under baseline resource usage levels. A required amount of money 325 is directed toward paying resource providers such as utilities and fuel providers. The amount 325 is determined by the monitoring and processing modules, and is adjustable 320. The difference 330 between amounts 317 and 320 is directed toward a pool 340 of money invested one or more financial instruments, as described herein. Additional value 345 may be added to the pool, for example via tax savings, carbon offset revenue, and other public or private incentives. Optionally, funds 350 may be drawn from the pool to finance equipment upgrades, retirement, or discretionary spending.

In embodiments of the present invention, utility bills are automatically paid in a timely manner, for example via the financial module. Other automatic payments may include loan payments and investments into specialized financial instruments such as described in Example 2. A portion of carbon offset revenues may be automatically deposited into a user's account or reinvested automatically via the financial module. A variety of transactions may be automatically performed, thereby managing items such as bill payments, regular investments, loan repayments, and the like.

### Feedback Module

Embodiments of the present invention comprise a feedback module configured to provide a user associated with the one or more devices with timely feedback indicative of one or more of: the resource usage data, the monetary value, and a status of the set of financial instruments. The feedback module may be operatively coupled to one or more of the monitoring module, the processing module, and the financial module, and configured to receive information therefrom for formatting and presentation. Timely feedback may comprise real-time feedback, on-demand feedback, or periodic feedback at a predetermined frequency, such as hourly, daily, or monthly. Timely feedback may facilitate corresponding timely response of the user to “close the loop” by possibly adjusting how they use certain devices.

The feedback module may comprise a special-purpose computer, a general-purpose computer configured via appropriate software, a remote server, a mobile device, or the like, or a combination thereof. The feedback module is configured to present data in a format which can be readily interpreted by a user, in order to inform the user as to their performance regarding resource conservation and to aid the user in making decisions which will impact future resource usage. Feedback may be displayed numerically, graphically, pictographically, or the like.

Feedback may be indicative of current usage of one or more resources, and may optionally contextualize current usage by also displaying usage history and/or predicted future usage. Feedback may comprise an indication of instantaneous usage, cumulative usage over a predetermined period, or a combination thereof.

Feedback may be indicative of monetary value flow associated with current usage of one or more resources, and may optionally contextualize monetary value flow by also displaying usage value flow history and/or predicted future value flow. Monetary value flow may be expressed in terms of present value or future value adjusted for one or more factors such as inflation, interest, and the like.

Feedback may be indicative of current financial instrument status flow as reported by financial institutions. This may be contextualized in terms of past status and predicted future status. Financial instrument status may be expressed in terms of present value or future value adjusted for one or more factors such as inflation, interest, and the like.

In some embodiments, the feedback module may display feedback keyed to specific resource conservation initiatives, such as installation of new equipment. Resource usage associated with such initiatives may be tagged or isolated so that it can be tracked independently of other resource usage. In some embodiments, the feedback module may display feedback indicative of progress toward a predetermined goal, such as a financial goal or a resource conservation goal.

In some embodiments, the feedback module may display resource usage data separately for a plurality of resources. In some embodiments, the feedback module may display aggregate resource usage data in meaningful units, such as gigajoules per square meter of building space per degree day in the case of home heating or cooling.

In some embodiments, the present invention may further facilitate automatic resource re-allocation and/or management of devices based at least in part on resource usage data, financial instrument status, or the like, or a combination thereof. In some embodiments, a building automation module may be configured to operate certain devices, for example turning lights and appliances on and off, adjusting heat, and the like. In some embodiments, the schedule of the building automation module may be adjusted based on monitored resource usage, for example discretionary usage. This may act to compensate for excess in discretionary resource usage, for example by turning down heat or turning lights or appliances off earlier. In some embodiments, the schedule of the building automation module may be adjusted based on financial instrument status. For example, if financial performance is lower than a threshold, the building automation module may manage devices to increase resource conservation. Limits may be placed on how much control the building automation module has over devices, to maintain predetermined operability and/or comfort level in the building.

### Database

Embodiments of the present invention may comprise or relate to a database, which obtains information relating to resource conservation and related context for a plurality of users. The database may be operatively coupled to a computer system and/or computer network, and configured to accumulate information acquired from the users periodically, via the computer system or network. The accumulated information may be subsequently accessed for use by the users or other parties. In some embodiments, the database may be configured to obtain information from one or more of the monitoring module, the processing module, and the financial module. For example, the database may acquire performance information regarding one or more appliances or devices which are monitored with respect to resource consumption, along with context information such as how the devices are used. The accumulated information may be used subsequently to provide information about various devices, for example to generate purchasing recommendations for efficient or cost-effective devices, vehicles, or the like. The database may grow in size and detail, becoming a substantially rich repository of information such as related to resource-efficiency matters.

In some embodiments, the database may be configured to acquire information related to user values, user behaviour, as well as device usage, device purchase preferences, device purchase date, device lifetime, device service requirements and costs, location, climate, and the like. The database may record or inherently correlations between several different types of data, and may thus be mined to uncover a variety of statistical or non-statistical information.

In some embodiments, the database may provide information to the processing module, monitoring or other module described herein. For example, the database may be configured to accumulate information regarding the rate of resource consumption of a particular device, which may be used to validate or adjust parameters in the monitoring module, processing module, or both.

The invention will now be described with reference to specific examples. It will be understood that the following examples are intended to describe embodiments of the invention and are not intended to limit the invention in any way.

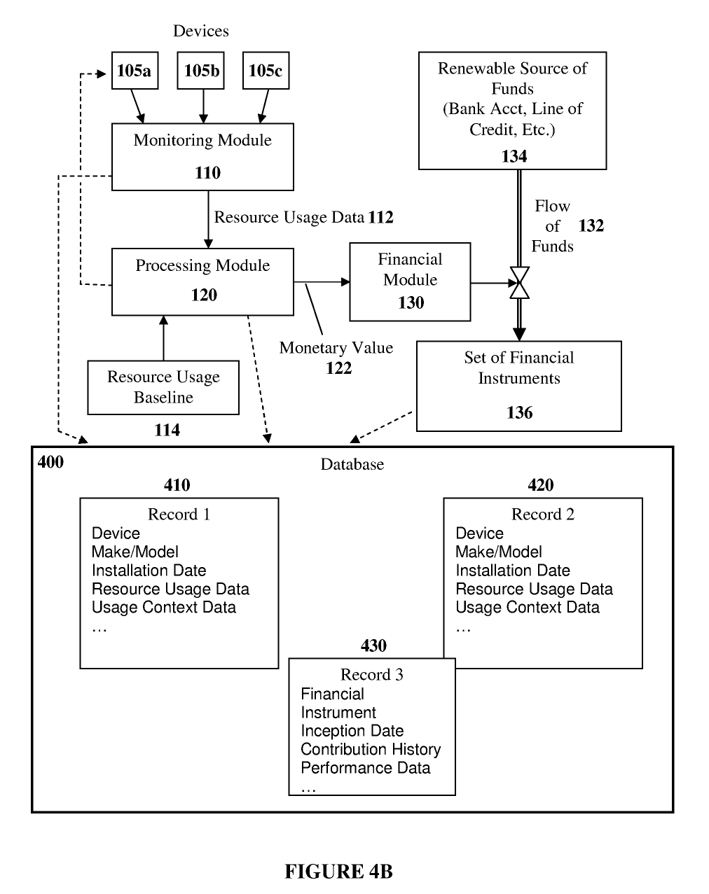

FIG. 4A illustrates a database 400 operatively coupled to one or more user systems 410a, 410b, 410c, 410d. The user systems may comprise systems for facilitating resource conservation, as described herein but directed to a single user, household, or the like. The database 400 may retrieve, store, and provide information to each user system, thereby connecting multiple users and allowing them to share information. Some information may be deemed confidential and thus not shared between users. Some information may be shared in aggregate or statistical form, or another form that preserves anonymity of individual users.

FIG. 4B illustrates a database 400 operatively coupled to a single user system, similar to that system described with respect to FIG. 1. The database 400 receives information from the monitoring module 1100e processing module 120, and information regarding the set of financial instruments 136. The database may thus track information regarding resource usage of individual devices, device usage, device usage context, resource usage costs, financial status, and other relevant information as described herein.

FIG. 4B further illustrates a plurality of exemplary database records 410, 420, 430. Records 410 and 420, for example, may relate to devices such as appliances, vehicles, heating ventilation and air-conditioning (HVAC) systems, related building envelope measures, and the like. Each of records 410 and 420 may comprise information such as a device descriptor, device make and model, installation date, resource usage data such as history of resource usage, average resource usage, and the like, and usage context information such as how and under what conditions the device is used, correlated with resource usage data. Record 430, for example, may relate to financial instrument, inception date, history of contributions to the instrument, performance data, and the like.

### EXAMPLES

### Example 1

In an exemplary embodiment, appliances, heating systems, and/or other equipment in a residential building may be upgraded to improve efficiency, for example via upgrades to the building envelope to improve heating and cooling efficiency. At the same time, an existing vehicle may be upgraded to a more efficient electric or hybrid gas/propane/electric vehicle. The total cost of the upgrades may be financed by a mortgage restructuring. The cost of the upgrades is projected to be about $128,000. The projected annual cost of energy, based on the present energy cost, is reduced from $5,730 to $1,990.

Without accounting for inflation, energy cost increases, and other factors, the projected payback period in this exemplary scenario is 34 years. However, this number may not be fully indicative of the actual energy savings. Rather, it is assumed in the present example that electricity prices increase at the rate of 6% per year, natural gas prices increase at 9% per year, and gasoline prices increase at 10% per year. Energy taxes such as carbon taxes are also assumed to increase from $20/tonne to about $190 per tonne over the next 25 years, in accordance with a curve which falls somewhat below the linear curve corresponding to a carbon tax rate of $20/tonne at present and an additional $6.8/tonne each year thereafter. In accordance with this scenario, energy costs may be reasonably expected to increase nearly ten-fold over the next 25 years. However, with the aforementioned upgrades, the total energy costs over the next 25 years may be reduced from $481,200 to about $120,900, which at least offsets the capital cost of the upgrades under reasonable financing assumptions.

Furthermore, after the capital cost of upgrades are paid off, the difference between what would have been spent on resources at a baseline usage rate and what is actually being spent may be invested, for example on a monthly basis, into a financial instrument such as a specialized Guaranteed Investment Certificate (GIC).

### Example 2

In another exemplary embodiment, a vehicle was upgraded to improve efficiency, by a retrofitting to add the capability of running on either gasoline or propane. The cost of the upgrades was about $4,500. The total cost of such upgrades may be paid up front, or it may be financed by an equipment loan.

It is assumed in the present example that gasoline prices increase at 10% per year. Energy taxes such as carbon taxes are also assumed to increase from $20/tonne to about $190 per tonne over the next 25 years, in accordance with a curve which falls somewhat below the linear curve corresponding to a carbon tax rate of $20/tonne at present and an additional $6.8/tonne each year thereafter. In accordance with this scenario, energy costs may be reasonably expected to increase nearly ten-fold over the next 25 years. However, with the aforementioned upgrades, the total fuel energy costs may be reduced from $4,030 per year to about $2,300, which at least offsets the capital cost of the upgrades under reasonable financing assumptions. The projected payback period in this exemplary scenario is 28 months, with a savings of $1,730 annually or $144 monthly.

Energy fuel savings may be due to various factors, such as the inherently lower current market price of propane versus gasoline or diesel, incentives such as free or discounted fuel provided for switching to propane, carbon offset revenue, bulk buying power if the energy fuel is purchased as part or a cooperative or other organization, and the like.

Furthermore, after the equipment loan of $4,500 is paid off, the difference between what would have been spent on resources at a baseline usage rate and what is actually being spent may be invested, for example on a monthly basis, into a financial instrument such as a specialized Guaranteed Investment Certificate (GIC). This may result in cumulative growth to $8,530 by the end of 5 years.

### Example 3

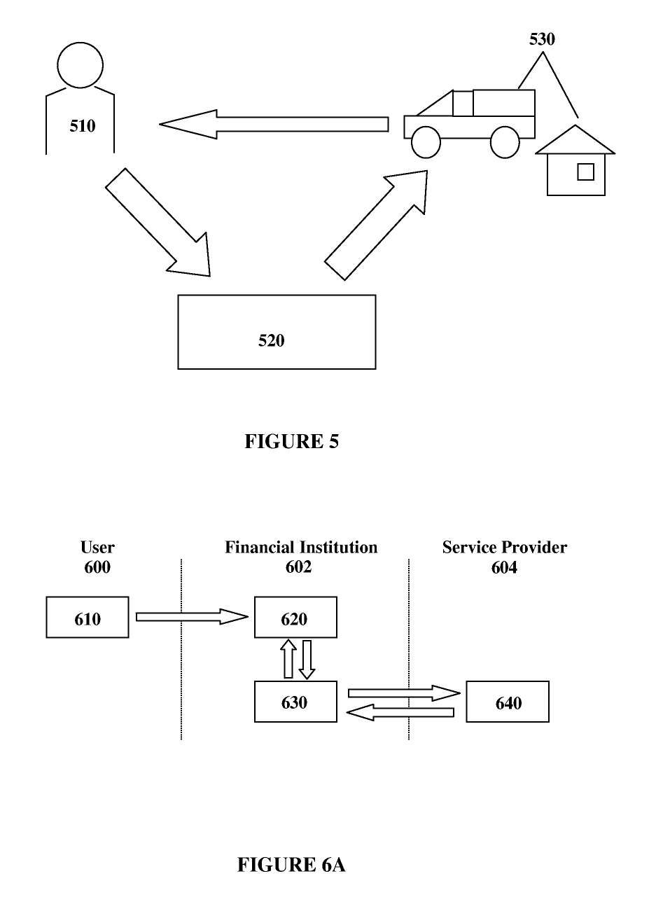

FIG. 5 illustrates an embodiment of the invention, wherein a user 510 invests in a specialized financial instrument 520 such as a specialized GIC. The financial instrument 520 may be tax sheltered. In some embodiments, the financial instrument 520 may be associated with a fund and may earn interest at a predetermined fixed or variable rate, for example 3.1%. Investments into the financial instrument 520 infuses capital into the fund, which may be used as a source of capital for issuing loans to approved borrowers, for example to finance capital investments 530, or the like, which will result in improved efficiency in resource consumption. Return may be based on growth from new subscriptions into the GIC fund as well as repayment of the issued loans. Return may also be based in part on carbon offset revenues realized due to qualifying capital investments 530.

Capital in the fund associated with the specialized financial instrument 520 may be used to finance qualifying capital investments 530 such as retrofits to automobiles, home appliances, building envelopes, and the like, may be financed. Monetary savings resulting from the capital investments 530, for example in the form of reduced utility bills, may be realized and benefit the borrower, which may include user 510, who may consume the monetary savings or reinvest them.

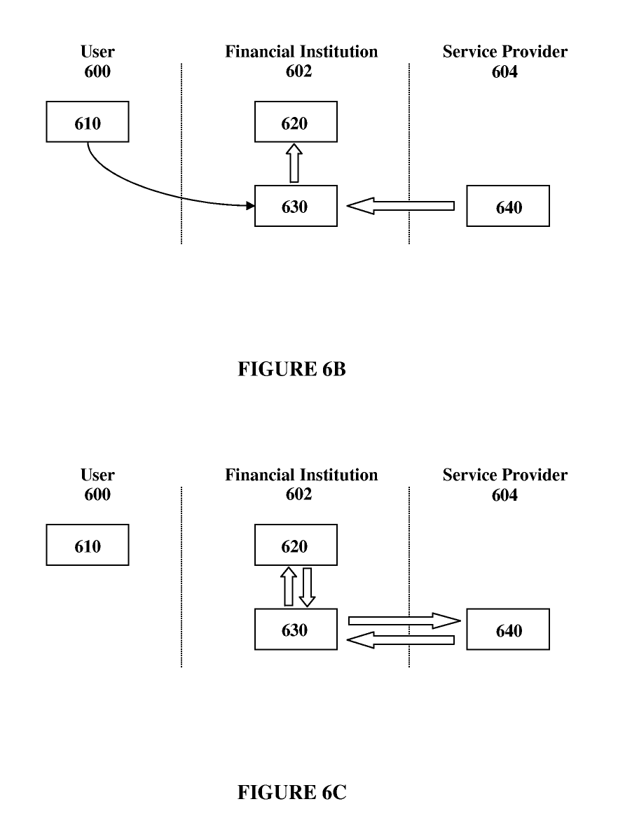

FIGS. 6A, 6B and 6C illustrate, in accordance with an embodiment of the present invention, automatic transactions between a plurality of accounts during three phases of an investment term. A user 600 holds an operating account 610, and an (optionally tax sheltered) investment account 620 held at a financial institution 602 such as a credit union. A service provider 604, such as an entity managing the investment fund, installation of systems for facilitating resource conservation, and/or issuance of loans for financing equipment upgrades, holds a fund account 630 at the financial institution 602 as well as an operating account 640. The fund account 630 holds the collective cash component of a plurality of individual investment account holdings in a specialized financial instrument such as a GIC. The operating account 640 is used by the service provider for conducting actual payment transactions for financing equipment upgrades of qualifying borrowers, and optionally other operating expenses of the service provider. From time to time and as both calculated by the service provider 604 and authorized by user 600, money will move between the accounts 620, 630, 640.

As illustrated in FIG. 6A, during the beginning of an investment term, the user 600 moves funds from their operating account 610 into their investment account 620. This money is used to purchase units of a financial instrument such as a GIC. The purchase involves flow of funds from the investment account 620 to the fund account 630. Funds flow from the fund account 630 to the operating account 640 as required to perform operations such as issuing loans which will result in a return on investment in the financial instrument. Return flows from the operating account 640 to the fund account 630 and is allocated and deposited periodically into the investment account 620.

FIG. 6B illustrates an intermediate period of the investment term, where return, for example from loan repayments, carbon offset credits and new investment, flows from the operating account 640 to the fund account 630 and is allocated and deposited periodically into the investment account 620. The user 600 may also optionally purchase units of the fund, for example via monthly transactions from account 610 to account 630.

FIG. 6C illustrates an end of the investment term, where the user's capital is returned from the fund account 630 and/or operating account 640 to the user's investment account 620. The user may then optionally reinvest in the fund account 630, and reinvestment may flow to the operating account 640 as needed.

### Example 4

As yet another example, vehicle-mounted sensors may measure and record fuel consumption for one or more types of fuels, as described herein. The fuel consumption data may be processed to determine projected fuel costs for a predetermined period such as a month. A predetermined amount, such as a dollar amount equal to a baseline fuel cost, may be deposited into a designated account periodically. Actual fuel bills, which will generally be less than the baseline fuel cost, are paid out of this account. A portion of the money remaining in the account after fuel bills are paid may be invested in a GIC, potentially generating credits such as RRSP credits, carbon credits, or the like. A portion of the money remaining in the account may also be used to pay down a loan taken out to convert the vehicle to a more efficient dual-fuel system. The fuel consumption data generated in real time via the vehicle-mounted sensors may be used to manage and/or adjust cash flow into and/or out of the designated account, as well as to update predictions of monetary savings provided to a user. For example, as fuel consumption goes up or down, predictions of future financial status may be adjusted in real time. If fuel consumption is at a level at which the designated account is in danger of being overdrawn, the user can be alerted to deposit more money into the account.

### Example 5

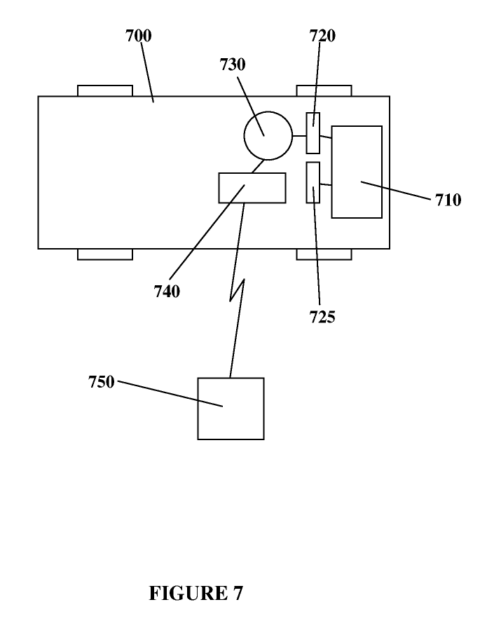

FIG. 7 illustrates aspects of a monitoring module for a vehicle 700. The vehicle comprises a hybrid engine 710, such as a dual-fuel propane-gasoline or propane-diesel engine. The engine 710 comprises one or more sensors which transmit information to the computers 720 and 725, which correspond to the main engine computer and the propane computer, respectively. Alternatively, information may be transmitted to a single computer. The computers 720 and 725 are configured to collect information such as instantaneous and cumulative fuel consumption for each type of fuel, cumulative distance travelled, and potentially other information sensed by vehicle sensors. The information is provided at a communication port 730 such as an ODB-II port, and recorded by a datalogger 740. The datalogger comprises a wireless communication module configured for transmitting stored and/or processed information to other monitoring module components, such as a smart phone fuel dispenser controller, or the like. In some embodiments, a dashboard mounted display may also be provided and connected to the datalogger and/or ODB-II port, the display configured to display information to the user in real time.

It will be appreciated that, although specific embodiments have been described herein for purposes of illustration, various modifications may be made without departing from the spirit and scope of the invention. In particular, it is within the scope of the invention to provide a computer program product or program element, or a program storage or memory device such as a transmission medium, non-transitory computer readable medium, magnetic or optical wire, tape or disc, or the like, for storing signals readable by a machine, for controlling the operation of a computer according to the method of the invention and/or to structure its components in accordance with the system of the invention.

In addition, while portions of the above discuss the invention as it can be implemented using a generic OS and/or generic hardware, it is within the scope of the present invention that the method, apparatus and computer program product of the invention can equally be implemented to operate using a non-generic OS and/or can use non-generic hardware.

Further, each step of the methods may be executed on a general computer, such as a personal computer, server or the like and pursuant to one or more, or a part of one or more, program elements, modules or objects generated from any programming language, such as C, C++, Java, Perl, PL/1, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A system for facilitating resource conservation, the system comprising:
a) a monitoring module configured to generate resource usage data indicative of consumption of one or more resources by one or more devices;
b) a processing module configured to automatically compare the resource usage data to a resource usage baseline, and to determine a monetary value indicative of at least a direct cost savings based on said comparison;
c) a financial module configured to automatically direct money equivalent in amount to said monetary value to a predetermined set of one or more financial instruments; and
d) a feedback module configured to provide a user associated with the one or more devices with timely feedback indicative of one or more of: the resource usage data, the monetary value, and a status of the set of financial instruments.

2. The system according to claim 1, wherein the monetary value is further indicative of one or more indirect values, each of the one or more indirect values determined based on the direct cost savings.

3. The system according to claim 2, wherein at least one of the indirect values is selected from the group comprising: a tax shelter value, a carbon offset credit, a government incentive, a private incentive, interest, equity, a value derived from using information obtained by the system, and a value derived from selling information obtained by the system.

4. The system according to claim 1, wherein at least one of the one or more resources is a consumable energy resource.

5. The system according to claim 1, wherein at least one of the one or more resources is water.

6. The system according to claim 1, wherein at least one of the one or more devices are selected from the group comprising: building appliances, building lighting systems, building heating systems, and automobiles.

7. The system according to claim 1, further comprising a database operatively coupled to at least one of the monitoring module, the processing module, and the financial module, the database configured to accumulate information relating to performance of the one or more devices.

8. The system according to claim 7, wherein the database is further configured to accumulate information relating to context of operation of the one or more devices.

9. The system according to claim 1, wherein the monitoring module comprises a vehicle-mounted portion operatively coupled to one or more sensors mounted in a vehicle, the vehicle-mounted portion comprising a datalogger for recording information obtained from the one or more sensors.

10. The system according to claim 9, wherein the vehicle-mounted portion is configured to automatically and wirelessly transmit the resource usage data to a receiver located at a fuelling station when the vehicle is refuelled, and wherein said receiver is configured to forward the resource usage data to another portion of the monitoring module, the processing module, or both.

11. The system according to claim 1, wherein the monitoring module is further configured to generate contextual data related to said resource usage data.

12. The system according to claim 1, wherein at least one of the financial instruments is a GIC having environmental features.

13. A method for facilitating resource conservation, comprising:
a) monitoring consumption of one or more resources by one or more devices and generating resource usage data indicative of said consumption;
b) automatically comparing the resource usage data to a resource usage baseline, and determining a monetary value indicative of at least a direct cost savings based on said comparison;
c) automatically directing money equivalent in amount to said monetary value to a predetermined set of one or more financial instruments; and
d) providing a user associated with the one or more devices with timely feedback indicative of one or more of: the resource usage data, the monetary value, and a status of the set of financial instruments, wherein the steps of monitoring, comparing, directing money, and providing feedback are implemented using one or more computing devices.

14. The method according to claim 13, wherein the monetary value is further indicative of one or more indirect values, each of the one or more indirect values determined based on the direct cost savings.

15. The method according to claim 14, wherein at least one of the indirect values is selected from the group comprising: a tax shelter value, a carbon offset credit, a government incentive, a private incentive, interest, equity, a value derived from using information obtained by the system, and a value derived from selling information obtained by the system.

16. The method according to claim 13, further comprising accumulating information in a database, the information relating to performance of the one or more devices.

17. The method according to claim 16, wherein the accumulated information relates at least in part to a context of operation of the one or more devices.

18. The method according to claim 13, wherein monitoring consumption of one or more resources module comprises monitoring and storing output of one or more sensors mounted in a vehicle.

19. The method according to claim 13, further comprising generating contextual data related to said resource usage data.

20. A computer program product comprising a non-transitory computer readable medium having computer readable code embodied therein, for execution by a CPU, for performing operations for facilitating resource conservation, the operations comprising:
a) automatically monitoring consumption of one or more resources by one or more devices and generating resource usage data indicative of said consumption;
b) automatically comparing the resource usage data to a resource usage baseline, and determining a monetary value indicative of at least a direct cost savings based on said comparison;
c) automatically directing money equivalent in amount to said monetary value to a predetermined set of one or more financial instruments; and
d) providing a user associated with the one or more devices with timely feedback indicative of one or more of: the resource usage data, the monetary value, and a status of the set of financial instruments.
